(19) United States
(12) Patent Application Publication
(10) Pub. No.: US 2025/0055590 A1
(43) Pub. Date: Feb. 13, 2025

(54) APPARATUS AND METHOD FOR DYNAMIC BANDWIDTH ALLOCATION FOR COHERENT OPTICAL ACCESS NETWORKS

(71) Applicant: Electronics and Telecommunications Research Institute, Daejeon (KR)

(72) Inventors: Jung-yeol OH, Daejeon (KR); Hun Sik KANG, Daejeon (KR)

(73) Assignee: Electronics and Telecommunications Research Institute, Daejeon (KR)

(21) Appl. No.: 18/780,694

(22) Filed: Jul. 23, 2024

(30) Foreign Application Priority Data
Aug. 11, 2023 (KR) 10-2023-0105330

(51) Int. Cl. H04J 14/08

(52) U.S. Cl. CPC H04J 14/08

(57) ABSTRACT

Proposed is an apparatus and method of dynamic bandwidth allocation for a coherent optical communication having a variable modulation and coding scheme in an optical access network, wherein the method includes determining an index of a received signal quality (I_{RSQ}) by measuring a received optical power (ROP) for downstream transmission, receiving a message of granting authority from a transport node (TN), transmitting a message of a buffer status report (BSR) to the TN in response to the message of grating authority, receiving from the TN a message of bandwidth allocation (BA) including an index of a modulation and coding scheme (I_{MCS}), and determining a modulation and coding scheme (MCS) corresponding to the index of the modulation and coding scheme (I_{MCS}) on the basis of the BA message.

### CROSS REFERENCE TO RELATED APPLICATION

The present application claims priority to Korean Patent Application No. 10-2023-0105330, filed on Aug. 11, 2023, the entire contents of which are incorporated herein for all purposes by this reference.

### BACKGROUND

### Technical Field

The present disclosure relates to a technology of dynamic bandwidth allocation for a coherent optical communication having a variable modulation and coding scheme in an optical access network and, more specifically, to an apparatus and method for controlling a modulation and coding scheme according to communication channel quality in an optical access network where a coherent technology is applied.

### Description of the Related Art

Time division multiplexing (TDM)-based optical access network technology has gained attention as the most cost-effective technology for accommodating not only broadband access and enterprise services, but also mobile communication networks such as the Internet of Things and autonomous vehicles.

FIG. 1 is a view showing a structure of a typical TDM-based optical access network. A transport node (TN) is a master optical transport network device in optical access networks, and is connected to a plurality of transport units (TUs) through an optical splitter to provide data services in a point-to-multi-point (P2MP) distribution manner.

In conventional optical access networks, intensity modulation and direct detection methods are the main technologies due to the ease of implementation, low power consumption, and cost-effective characteristics. However, it is increasingly difficult for intensity modulation and direct detection methods to meet the performance required by optical access networks because recently the signal to noise ratio (SNR) is decreasing as the transmission bandwidth of the optical access network continuously increases. Coherent optical communication technology has not been applied to optical access networks due to the optical complexity, high power consumption, and high costs compared to intensity modulation and direct detection methods, but numerous studies have recently been conducted to apply coherent technology to the optical access network due to numerous advantages of coherent technology, such as high spectral efficiency, high receiver sensitivity, unique frequency selectivity, and effective dispersion compensation using digital signal processing (DSP).

### SUMMARY

The objective of the present disclosure is to increase upstream bandwidth efficiency and improve packet delay characteristics by effectively controlling modulation and coding schemes according to communication channel quality in an optical access network to which coherent technology is applied.

A method of operating a transport unit (TU) for dynamic bandwidth allocation (DBA) in a coherent optical access network having a variable modulation and coding scheme according to an exemplary embodiment of the present disclosure includes determining an index of a received signal quality (I_{RSQ}) by measuring a received optical power (ROP) for downstream transmission, receiving a message of granting authority from a transport node (TN), transmitting a message of a buffer status report (BSR) to the TN in response to the message of grating authority, wherein the BSR message includes information on the index of the received signal quality (I_{RSQ}), receiving from the TN a message of bandwidth allocation (BA) including an index of a modulation and coding scheme (I_{MCS}), and determining a modulation and coding scheme (MCS) corresponding to the index of the modulation and coding scheme (I_{MCS}) on the basis of the BA message.

In addition, the method further includes generating a packet by modulating data to be transmitted on the basis of the determined MCS into a transport block size (TBS) and transmitting the packet to the TN through upstream transmission during an allocated upstream transmission time.

In addition, determining the index of the received signal quality (I_{RSQ}) is performed on the basis of a first mapping table that stores the ROP and the index of the received signal quality (I_{RSQ}) in advance.

In addition, determining the modulation and coding scheme (MCS) is performed on the basis of a second mapping table that stores the index of the received signal quality (I_{RSQ}) and the index of the modulation and coding scheme (I_{MCS}) in advance.

In addition, determining the index of the received signal quality (I_{RSQ}) by measuring the received optical power (ROP) for downstream transmission further includes compensating the ROP on the basis of a difference between the P_{TN} and the P_{TU} when a transmitter power for the TN (P_{TN}) and a transmitter power for the TU (P_{TU}) are different from each other.

In addition, determining the index of the received signal quality (I_{RSQ}) by measuring the received optical power (ROP) for downstream transmission further includes determining a received optical power (ROP) that meets a bit error ratio (BER) limit for at least one modulation and code rate.

A method of operating a transport node (TN) for dynamic bandwidth allocation (DBA) in a coherent optical access network having a variable modulation and coding scheme according to an exemplary embodiment of the present disclosure includes transmitting a message of granting authority to a transport unit (TU), receiving a message of a buffer status report (BSR) from the TU in response to the message of granting authority, wherein the BSR message includes information on an index of a received signal quality (I_{RSQ}), determining an index of a modulation and coding scheme (I_{MCS}) corresponding to the index of the received signal quality (I_{RSQ}), transmitting to the TU a message of bandwidth allocation (BA) including the index of the modulation and coding scheme (I_{MCS}), and determining a modulation and coding scheme (MCS) corresponding to the index of the modulation and coding scheme (I_{MCS}) on the basis of the BA message.

In addition, before transmitting the BA message, the method further includes determining a transport block size (TBS) of data to be transmitted using the MCS corresponding to the index of the modulation and coding scheme (I_{MCS}), wherein the BA message further includes a transmission time and transmission window size of upstream transmission and the TBS.

In addition, the BA message is performed in consideration of a round trip delay (RTT) and an upstream transmission preparation time.

An apparatus of a transport unit (TU) for dynamic bandwidth allocation (DBA) in a coherent optical access network having a variable modulation and coding scheme according to an exemplary embodiment of the present disclosure includes a transceiver and at least one controller operably connected to the transceiver, wherein the at least one controller performs determining an index of a received signal quality (I_{RSQ}) by measuring a received optical power (ROP) for downstream transmission, receiving a message of granting authority from a transport node (TN), transmitting a message of a buffer status report (BSR) to the TN in response to the message of grating authority, wherein the BSR message includes information on the index of the received signal quality (I_{RSQ}), receiving from the TN a message of bandwidth allocation (BA) including an index of a modulation and coding scheme (I_{MCS}), and determining a modulation and coding scheme (MCS) corresponding to the index of the modulation and coding scheme index (I_{MCS}) on the basis of the BA message.

In addition, the at least one controller further performs generating a packet by modulating data to be transmitted on the basis of the determined MCS into a transport block size (TBS) and transmitting the packet to the TN through upstream transmission during an allocated upstream transmission time.

In addition, determining the index of the received signal quality (I_{RSQ}) is performed on the basis of a first mapping table that stores the ROP and the index of the received signal quality (I_{RSQ}) in advance.

In addition, determining the modulation and coding scheme (MCS) is performed on the basis of a second mapping table that stores the index of the received signal quality index (I_{RSQ}) and the index of the modulation and coding scheme index (I_{MCS}) in advance.

In addition, the at least one controller further performs compensating the ROP on the basis of a difference between the P_{TN} and the P_{TU} when a transmitter power for the TN (P_{TN}) and a transmitter power for the TU (Pru) are different from each other, in order to determine the index of the received signal quality (I_{RSQ}) by measuring the received optical power (ROP) for downstream transmission.

In addition, the at least one controller further performs determining a received optical power (ROP) that meets a bit error ratio (BER) limit for at least one modulation and code rate, in order to determine the index of the received signal quality (I_{RSQ}) by measuring the received optical power (ROP) for downstream transmission.

An apparatus of a transport node (TN) for dynamic bandwidth allocation (DBA) in a coherent optical access network having a variable modulation and coding scheme according to an exemplary embodiment of the present disclosure includes a transceiver and at least one controller operably connected to the transceiver, wherein the at least one controller performs transmitting a message of granting authority to a transport unit (TU), receiving a message of a buffer status report (BSR) from the TU in response to the message of grating authority, wherein the BSR message includes information on the index of the received signal quality (I_{RSQ}), determining an index of a modulation and coding scheme (I_{MCS}) corresponding to the index of the received signal quality (I_{RSQ}), transmitting to the TN a message of bandwidth allocation (BA) including the index of the modulation and coding scheme (I_{MCS}), and determining a modulation and coding scheme (MCS) corresponding to the index of the modulation and coding scheme (I_{MCS}) on the basis of the BA message.

In addition, the at least one controller further performs determining a transport block size (TBS) of data to be transmitted on the basis of the MCS corresponding to the index of the modulation and coding scheme (I_{MCS}) before performing transmitting the BA message, wherein the BA message further includes a transmission time and transmission window size of upstream transmission and the TBS.

In addition, transmitting the BA message is performed in consideration of a round trip delay (RTT) and an upstream transmission preparation time.

The present disclosure has the advantage of increasing upstream bandwidth efficiency and improving packet delay characteristics by effectively controlling modulation and coding schemes according to communication channel quality in an optical access network to which coherent technology is applied.

### BRIEF DESCRIPTION OF THE DRAWINGS

FIG. 1 is a view showing a structure of a typical TDM-based optical access network.

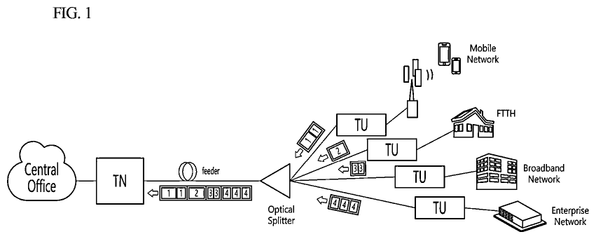

FIG. 2 is a view showing a conventional DBA procedure for upstream transmission in an optical access network.

FIG. 3 is a view showing an example of a received optical power (ROP) that meets a bit error ratio (BER) performance for each modulation and code rate.

FIG. 4 is a view showing a DBA procedure performed in a TU according to an exemplary embodiment of the present disclosure.

FIG. 5 is a view showing a DBA procedure performed in a TN according to an exemplary embodiment of the present disclosure.

FIG. 6 is a view showing a first step of operating an optical access network having a variable modulation and coding scheme according to an exemplary embodiment of the present disclosure.

FIG. 7 is a view showing a second step of operating an optical access network having a variable modulation and coding scheme according to an exemplary embodiment of the present disclosure.

FIG. 8 is a view showing a third step of operating an optical access network having a variable modulation and coding scheme according to an exemplary embodiment of the present disclosure.

FIG. 9 is a view showing a fourth step of operating an optical access network having a variable modulation and coding scheme according to an exemplary embodiment of the present disclosure.

### DETAILED DESCRIPTION OF THE DISCLOSURE

Phrases such as “in some exemplary embodiments” or “in one exemplary embodiment” that appear in various places in this specification do not necessarily all refer to the same exemplary embodiment.

Some exemplary embodiments of the present disclosure may be represented by functional block configurations and various processing steps. Some or all of these functional blocks may be implemented in any number of hardware and/or software configurations that perform specific functions. For example, the functional blocks of the present disclosure may be implemented by one or more microprocessors, or may be implemented by circuit configurations for certain functions. Also, for example, the functional blocks of the present disclosure may be implemented in various programming or scripting languages. The functional blocks may be implemented by an algorithm executed on one or more processors. In addition, the present disclosure may employ conventional technologies for electronic environment setup, signal processing, and/or data processing. Terms such as “mechanisms”, “elements”, “means”, “configurations”, and the like may be widely used and are not limited to mechanical and physical configurations.

In addition, connection lines or connection members between components shown in the drawings merely exemplify functional connections and/or physical or circuit connections. In actual devices, connections between components may be represented by a variety of alternative or additional functional, physical, or circuit connections.

The present disclosure may relate to a method of configuring a coherent optical access network having a variable modulation and coding scheme, which increases upstream bandwidth efficiency and improves packet delay characteristics in an optical access network.

Specifically, a data transmission method in TDM-based optical access networks may have the following characteristics. In the case of downstream transmission where data is transmitted from a TN to a TU, a data packet may be transmitted in a broadcast way, and in the case of upstream transmission where data is transmitted from the TU to the TN, a plurality of TUs may share the same upstream channel with each other through a time-division scheduling in order to share resources with each other without conflicts between data transmissions.

In TDM-based optical access networks, a typical scheduling scheme for upstream transmission of the TU may be a dynamic bandwidth allocation (DBA) method. The DBA may use a status reporting (SR) method where the TN receives information on the current buffer status from a plurality of TUs and determines bandwidth allocation for each TU's upstream transmission on the basis of information on the notified buffer status report.

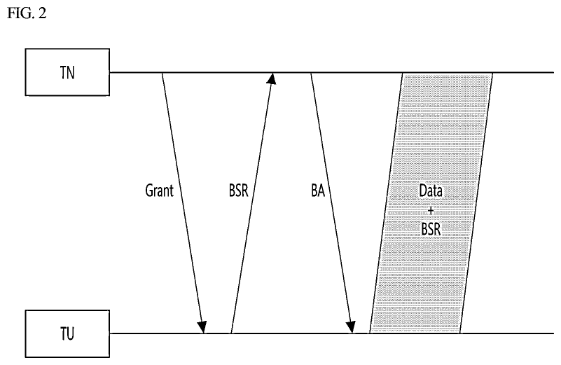

FIG. 2 is a view showing a conventional DBA procedure for upstream transmission in an optical access network.

The TN may transmit a message of granting authority to all TUs registered in a network in order to allocate a minimum amount of bandwidth, so that a buffer status to be transmitted is reported via upstream transmission. Each TU may report the amount of buffer of the current upstream transmission to the TN via the message of the buffer status report (BSR) at the bandwidth allocation time allocated by the granting message. The DBA scheduler of the TN may perform to allocate the bandwidth for each TU's upstream transmission in consideration of the amount of the buffer of upstream transmission, round trip delay (RTT), and upstream transmission preparation time of each TU reported in the BSR and may transmit to each TU a message of bandwidth allocation for the upstream transmission time and window size. The TU may transmit packets to the TN through upstream transmission during the upstream transmission time allocated in the BA message. In addition, the TU may transmit the remaining amounts of the buffer of upstream transmission together to the TN after transmission for the next upstream transmission.

In this way, the DBA may increase upstream bandwidth efficiency through flexible bandwidth allocation of upstream transmission for each TU. However, the packet delay may inevitably increase due to the time the TU waits in the buffer from the time reporting the buffer status to the time transmitting data.

Conventionally, the DBA method with high bandwidth efficiency was mainly used in optical access networks because the requirements for tolerance of packet delay were not very high, but in recent years, mobile networks have been increasingly demanding low-latency characteristics for large amounts of multimedia data as well as ultra-realistic services. Due to such a demand, upstream transmission of the TDM-based optical access network may be increasingly required to be more bandwidth efficient and improve packet delay performance.

The existing optical transmission method with intensity modulation and direct detection may have a fixed function according to the selected optical communication method, but since the coherent optical transmission and optical detection method detects optical signals by tracking not only the optical intensity but also the phase of the optical signal, flexible optical communication may be possible by adjusting parameters such as transmission distance, transmission capacity, and spectral efficiency through software control while using digital signal processing. When a symbol rate is fixed to make the size of the allocation bandwidth of an optical component constant, the data rate may vary according to a modulation order and code rate.

The modulation order may define an effective bit that can be transmitted in a single symbol, and the modulation order is as shown in [Equation 1] to [Equation 4] below, assuming that the modulation method of QPSK, 16-QAM, and 64-QAM is performed.

$$Modulation Order ( M ) = {log}_{2} M \qquad [ Equation 1 ]$$

$$QPSK = {log}_{2} 4 = 2 \qquad [ Equation 2 ]$$

$$16 Q AM = {log}_{2} 16 = 4 \qquad [ Equation 3 ]$$

$$64 Q AM = {log}_{2} 64 = 6 \qquad [ Equation 4 ]$$

The QPSK may transmit 2 bits per symbol, the 16-QAM may transmit 4 bits per symbol, and the 64-QAM may transmit 6 bits per symbol. The code rate may be defined as the ratio between the actual information bits (k) and the total encoded codeword bits (n: information bit+parity bit) when encoding information bits for a forward error correction (FEC) for error correction and detection.

$$Code Rate ( R ) = \frac{k}{n} \qquad [ Equation 5 ]$$

In this way, as the received signal quality of the optical link is higher, the signal may be transmitted with a higher modulation order and higher code rate. Table 1 below may show an example of mapping the spectral efficiency according to the modulation order (M) and code rate (R) to the index of the modulation and code scheme (I_{MCS}).

TABLE 1

| I_{MCS} | Modulation (M) | Code Rate (R) | Spectral Efficient (SE) |
|---|---|---|---|
| 0 | 2 | 0.6 | 1.2 |
| 1 | 2 | 0.9 | 1.8 |
| 2 | 4 | 0.7 | 2.8 |
| 3 | 4 | 0.9 | 3.6 |
| 4 | 6 | 0.8 | 4.8 |
| 5 | 6 | 0.9 | 5.4 |

The spectral efficiency may refer to the maximum number of bits that can be transmitted in a specific bandwidth, and as the spectral efficiency is higher, more data may be transmitted in a given bandwidth. Therefore, as the received signal quality of the optical link is higher, more data may be transmitted because of selecting the modulation and coding scheme (MCS) having a higher index of modulation and code scheme (I_{MCS}) to support higher spectral efficiency.

In the optical access network, as the received optical power (ROP) is higher, the received signal quality (RSQ) may be generally higher, and as the received optical power is lower, the received signal quality may be worse. Like a passive optical network (PON), in the optical access network, optical signals may be distributed to multiple user nodes on a single optical fiber through passive optical components such as a passive optical splitter. When an optical signal is distributed to multiple receivers through an optical splitter, the received optical power may be lowered in proportion to the number of branches. As the number of branches increases, the received optical power reaching the receiver may decrease, and as the received optical power decreases, the received quality may decrease. Therefore, the strength of the received optical power may be very closely related to the quality of the received signal in the optical access network. Downstream transmission and upstream transmission may have different optical wavelengths but pass through the same optical fiber channel, so that the received signal power of downstream transmission may be approximated to that of upstream transmission. Therefore, the TU may measure the received optical power using broadcast packets of downstream transmission, and this may be utilized as an indicator of the received signal quality of upstream transmission.

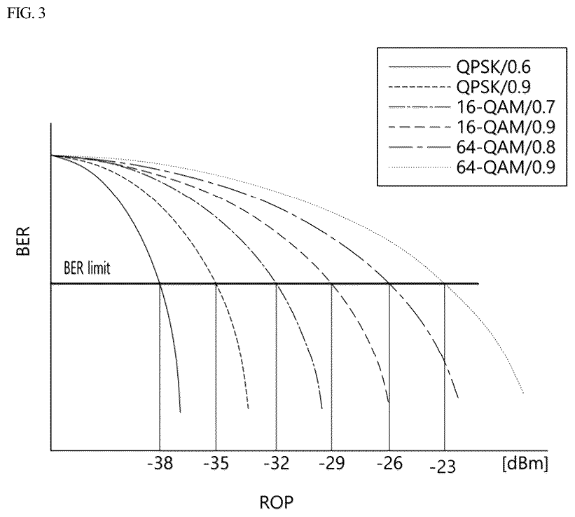

FIG. 3 is a view showing an example of a received optical power (ROP) that meets a bit error ratio (BER) performance for each modulation and code rate.

According to FIG. 3, when the modulation and coding scheme (MCS) is QPSK/0.6, the received optical power (ROP) may need to be greater than or equal to −38 dBm in order to meet the BER limit required by the system. When the MCS is QPSK/0.9, the received optical power (ROP) may need to be greater than or equal to −35 dBm, when the MCS is 16-QAM/0.7, the received optical power (ROP) may need to be greater than or equal to −32 dBm, when the MCS is 16-QAM/0.9, the received optical power (ROP) may need to be greater than or equal to −29 dBm, when the MCS is 64-QAM/0.8, the received optical power (ROP) may need to be greater than or equal to −26 dBm, and when the MCS is 64-QAM/0.9, the received optical power (ROP) may need to be greater than or equal to −23 dBm.

On the basis of these results, the index of the received signal quality may be determined as follows. Table 2 below may show an example of determining the received signal quality (RSQ) according to the received optical power (ROP) and mapping the same to the index of the received signal quality (I_{RSQ}).

TABLE 2

| I_{RSQ} | ROP | RSQ | Description |
|---|---|---|---|
| S | >=−23 dBm | Excellent | signal quality strong |
| | | | enough to support |
| | | | maximum data rates |
| A | −26 dBm~−23 dBm | Very Good | signal quality strong |
| | | | enough to support |
| | | | relatively high data rates |
| B | −29 dBm~−26 dBm | Good | signal quality strong enough |
| | | | to support good data rates |
| C | −32 dBm~−29 dBm | Normal | signal quality normal to |
| | | | support general data rates |
| D | −35 dBm~−32 dBm | Poor | signal quality weak to |
| | | | support low data rates |
| E | −38 dBm~−35 dBm | Very Poor | signal quality weak to support |
| | | | minimum data rates |

The index of the received signal quality (I_{RSQ}) may be mapped to the index of the modulation and code scheme (I_{MCS}) as shown in Table 3. The supportable MCS may be determined when the quality of the received signal is measured through Table 3 below.

TABLE 3

| I_{MCS} | MCS | I_{RSQ} | RSQ |
|---|---|---|---|
| 0 | QPSK/0.6 | E | Very Poor |
| 1 | QPSK/0.9 | D | Poor |
| 2 | 16-QAM/0.7 | C | Normal |
| 3 | 16-QAM/0.9 | B | Good |
| 4 | 64-QAM/0.8 | A | Very Good |
| 5 | 64-QAM/0.9 | S | Excellent |

At this time, it may be assumed that the transmitted optical signal power of the TN and the transmitted optical signal power of the TU are the same. When the transmitter power of the TN and the transmitter power of the TU are different from each other, compensation may be necessary to calculate the received optical power of the TU as shown in Equation 6 to Equation 9. Specifically, power compensation may be performed on the basis of the difference in transmitted optical signal power for the TN and the TU.

$$RoP ← RoP + ( {P}_{TN} - {P}_{TU} ) \qquad [ Equation 6 ]$$

RoP: Received Optical Power at TU [Equation 7]

P_{TN}: Transmitter Power for TN [Equation 8]

P_{TU}: Transmitter Power for TU [Equation 9]

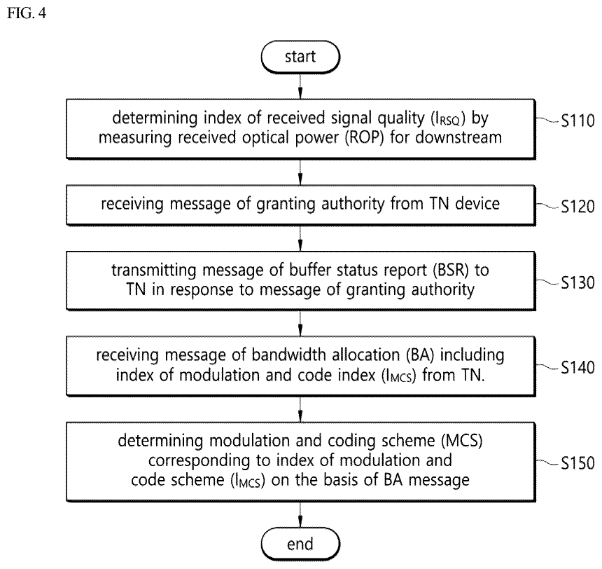

FIG. 4 is a view showing a DBA procedure performed in a TU according to an exemplary embodiment of the present disclosure.

In the step S110, the TU device may determine the index of the received signal quality (I_{RSQ}) by measuring the received optical power (ROP) for downstream transmission.

Specifically, the index of the received signal quality (I_{RSQ}) may be determined on the basis of a first mapping table that stores the ROP and the index of the received signal quality (I_{RSQ}) in advance. Herein, the first mapping table may be a table of Table 2 as an example.

In addition, the TU device may determine the transmitter power (P_{TN}) of the TN device and the transmitter power (P_{TU}) of the TU device in advance, and when the P_{TN} and P_{TU} are different from each other, the ROP may be compensated on the basis of the difference between the P_{TN} and the P_{TU}. This compensation process may be performed on the basis of Equation 6 to Equation 9.

In addition, the TN device may determine the received optical power (ROP) to meet the bit error ratio (BER) limit for at least one modulation and code rate.

In the step S120, the TU device may receive a message of granting authority from the TN device.

Specifically, the TN device may transmit a message of granting authority for allocating a minimum amount of bandwidth to the at least one TU device registered in the optical access network so that the buffer status to be transmitted can be reported in upstream transmission.

At least one TU device that obtains the message of granting authority may report to the TN device the amount of the buffer of upstream transmission at the bandwidth allocation time allocated by the message of granting authority.

In the step S130, the TU device may transmit a message of a buffer status report (BSR) to the TN in response to the message of granting authority.

Herein, the BSR message may include information on the amount of the buffer of upstream transmission. Along with the BSR message, the TU device may transmit information about the index of the received signal quality (I_{RSQ}) to the TN device.

In the step S140, the TU device may receive a message of bandwidth allocation (BA) including the index of the modulation and code index (I_{MCS}) from the TN.

Herein, the message of bandwidth allocation may include information on bandwidth allocation for the upstream transmission time and the window size. More specifically, the DBA scheduler of the TN device may perform bandwidth allocation for upstream transmission of at least one TU device in consideration of at least one of the amount of the buffer of upstream transmission, a round trip delay (RTT), and an upstream transmission preparation time of the at least one TU device reported in BSR. In addition, the TN device may transmit the message of bandwidth allocation (BA) for the upstream transmission time and window size to at least one TU device according to bandwidth allocation.

In the step S150, the TU device may determine the modulation and coding scheme (MCS) corresponding to the index of the modulation and code scheme (I_{MCS}) on the basis of the BA message.

Herein, the MCS may be determined on the basis of a second mapping table that stores the index of the received signal quality (I_{RSQ}) and the index of the modulation and code scheme (I_{MCS}) in advance. Herein, the second mapping table may be a table of Table 3 as an example.

Thereafter, the TU device may generate a transmission packet by modulating data into the transport block size (TBS) on the basis of the determined MCS. The generated packet may be transmitted to the TN via upstream transmission during the transmission window size at the allocated upstream transmission start time.

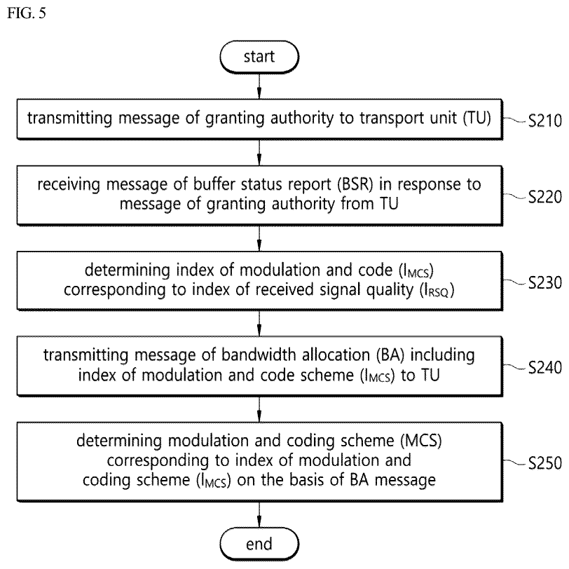

FIG. 5 is a view showing a DBA procedure for a coherent optical access network having a variable modulation and coding scheme performed in a TN according to an exemplary embodiment of the present disclosure.

In the step S210, the TN device may transmit the message of granting authority to a transport unit (TU).

Specifically, the message of granting authority may be a message for allocating a minimum amount of bandwidth so that the buffer status to be transmitted can be reported in upstream transmission to at least one TU device registered in the optical access network.

In the step S220, the TN device may receive from the TU the message of the buffer status report (BSR) in response to the message of granting authority.

Herein, the BSR message may include information on the index of the received signal quality (I_{RSQ}).

In the step S230, the TN device may determine the index of the modulation and code (I_{MCS}) corresponding to the index of the received signal quality (I_{RSQ}).

In addition, the TN device may determine the transport block size (TBS) of the data to be transmitted for transmitting the buffer size of the BSR message on the basis of the MCS corresponding to the index of the modulation and code scheme (I_{MCS}). The operation of determining the TBS may be performed before the step S240 described later.

In the step S240, the TN device may transmit a message of bandwidth allocation (BA) including the index of the modulation and code scheme (I_{MCS}) to the TU.

Here, the BA message may further include the upstream transmission time, a transmission window size, and the TBS. In addition, the TN device may consider a round trip delay (RTT) and an upstream transmission preparation time in order to transmit the BA message.

In the step S250, the TN device may determine the modulation and coding scheme (MCS) corresponding to the index of the modulation and coding scheme (I_{MCS}) on the basis of the BA message. The TN device may recover the upstream packets received from the TU device in a way of the modulation and coding scheme determined by the MCS.

Each operation constituting the upstream DBA procedure of the optical access network shown in FIGS. 4 and 5 may be exemplified in time series as follows. Each operation below may be separately performed in the TN device or TU device.

1. The TU device may determine the index of the received signal quality (I_{RSQ}) by measuring the received optical power (ROP) of downstream transmission.

2. The TN device may request the buffer status report of upstream transmission by transmitting the message of granting authority to the TU device.

3. The TU device may report to the TN the index of the received signal quality (I_{RSQ}) along with the BSR message.

4. The DBA of the TN device may transmit downstream the BA message which includes the upstream transmission time, the transmission window size, the modulation and transport block size, and the index of the modulation and code scheme (I_{MCS}) in consideration of the round trip delay (RTT), and the upstream transmission preparation time after selecting the index of the modulation and code scheme (I_{MCS}) for the index of the received signal quality (I_{RSQ}) of the TU device and then determining the transport block size (TBS) to be transmitted using the corresponding MCS.

5. The TU device may modulate as many as the transport block size (TBS) using the MCS corresponding to the index of the modulation and code scheme (I_{MCS}) contained in the BA message, and then may transmit packets to the TN device through upstream transmission during the allocated upstream transmission time along with a request message for the remaining amounts of the buffer of upstream transmission.

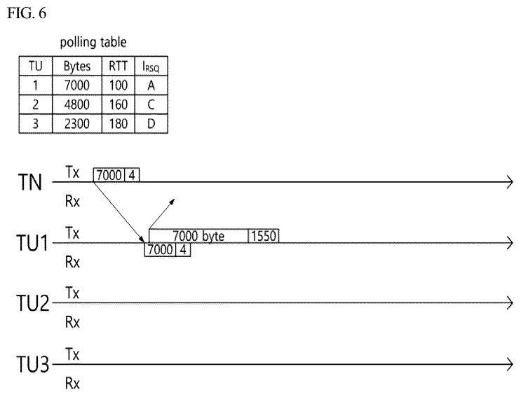

FIGS. 6 to 9 are views showing an exemplary embodiment of an optical access network having variable modulation and coding schemes, assuming a system having three TUs.

FIG. 6 is a view showing a first step of operating an optical access network having a variable modulation and coding scheme according to an exemplary embodiment of the present disclosure.

In FIG. 6, the TN may receive reports of BSR and the index of the received signal quality (I_{RSQ}) from each TU and may store into the polling table how much the upstream data is waiting in the buffer of the TU and how much the RTT and the index of the received signal quality (I_{RSQ}) of the TU are.

At a specific time t0, the DBA of the TN may calculate not only the index (4) of the modulation and code scheme (I_{MCS}) for the index (A) of the received signal quality (I_{RSQ}) of the TU1, but also the transport block size (TBS, 7000 bytes in the example) to be transmitted using the corresponding MCS, and may direct the BA control message, which includes the transmission time and transmission window size of upstream transmission, to be transmitted downstream. In downstream transmission, the TN may broadcast the downstream packets to all TUs, so the control message may include the ID of the destination TU to distinguish the packets.

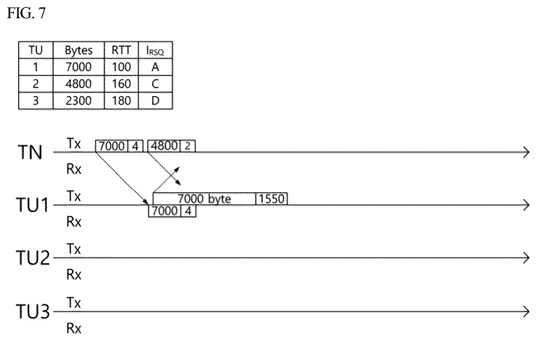

FIG. 7 is a view showing a second step of operating an optical access network having a variable modulation and coding scheme according to an exemplary embodiment of the present disclosure.

In FIG. 7, when the TU1 receives the BA control message from the TN, the TU1 may transmit packets through upstream transmission from the start of the allocated upstream transmission time up to the transport block size (TBS) of 7000 bytes by modulating and encoding data to be transmitted using the MCS corresponding to the index (4) of the given modulation and code scheme (I_{MCS}). At the same time, the TU1 may continuously receive new data packets from a user network interface (UNI). At a point where the transmission window ends, the TU1 may generate a request control message that indicates how many bytes of data remain in the buffer. In FIG. 7, the number of bytes of data remaining in the buffer is 1550 bytes. The TN may know when the last symbol of the upstream packet of the TU1 arrives before receiving the upstream packet from the TU1 through the following procedure.

(1) The upstream packet of the TU1 may accurately arrive after the RTT time after the upstream transmission time of the TU1. Herein, the RTT may include the actual RTT, the upstream transmission preparation time of TU1, and the time for the TN to detect a preamble that indicates the start of data in the received packet.

(2) Since knowing both the size of the data that TU1 will transmit and the modulation and coding scheme, the TN may know when the last symbol of the upstream packet of the TU1 arrives. Then, knowing the RTT for TU2, the TN may generate the BA control message to ensure that the first symbol of TU2's upstream packet arrives immediately after the last symbol of TU1's upstream packet, with a small protection gap in between.

Before receiving the upstream packet from TU1, the TN may calculate not only the index (2) of the modulation and code scheme (I_{MCS}) for the index (C) of the received signal quality (I_{RSQ}) of the TU2, but also the transport block size (TBS, 4800 bytes) to be transmitted using the corresponding MCS, and may direct the BA control message, which includes the transmission time and transmission window size of upstream transmission, to be transmitted downstream.

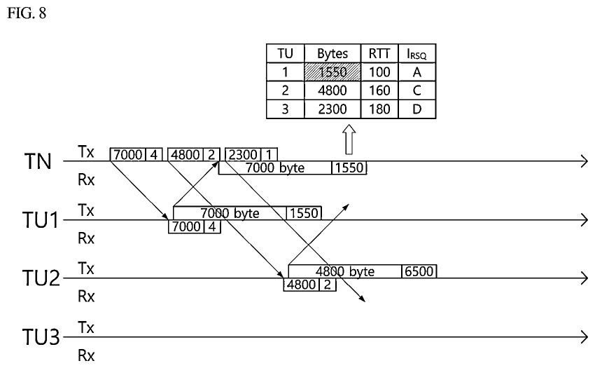

FIG. 8 is a view showing a third step of operating an optical access network having a variable modulation and coding scheme according to an exemplary embodiment of the present disclosure.

In FIG. 8, when the upstream packet of the TU1 arrives at the TN and the transmission of the upstream data ends in the TU1, a request control message may begin, and the TN may update the polling table with information on the new request data of the request control message. In FIG. 8, the information on the new request data is 1550 bytes.

As in the upper step, when the TU2 receives the BA control message from the TN, the TU2 may transmit packets through upstream transmission from the start of the allocated upstream transmission time up to the transport block size (TBS) of 4800 bytes by modulating and encoding data to be transmitted using the MCS corresponding to the index (2) of the given modulation and code scheme (I_{MCS}). At the same time, the TU2 may continuously receive new data packets from the user network interface (UNI). At a point where the transmission window ends, the TU2 may generate the request control message that indicates how many bytes of data remain in the buffer. In FIG. 8, the number of bytes of data remaining in the buffer is 6500 bytes.

As in the upper step, The TN may know when the last symbol of the upstream packet of the TU2 arrives. Therefore, it may be known when to transmit the BA control message for the TU3. After a while, when the packet of the TU2 arrives, the TN may update again the polling table with data for the request control message for the TU2.

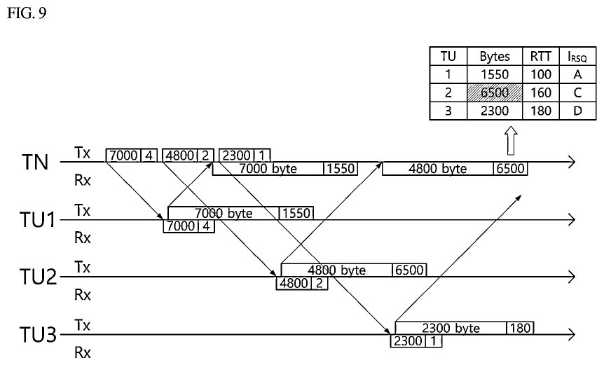

FIG. 9 is a view showing a fourth step of operating an optical access network having a variable modulation and coding scheme according to an exemplary embodiment of the present disclosure.

In FIG. 9, before receiving the upstream packet from TU2, the TN may calculate not only the index (1) of the modulation and code scheme (I_{MCS}) for the index (D) of the received signal quality (I_{RSQ}) of the TU3, but also the transport block size (TBS, 2300 bytes) to be transmitted using the corresponding MCS, and may transmit downstream the BA control message including the transmission time of upstream transmission.

As in the upper step, when the TU3 receives the BA control message from the TN, the TU3 may transmit packets through upstream transmission from the start of the allocated upstream transmission time up to the transport block size (TBS) of 2300 bytes by modulating and encoding data to be transmitted using the MCS corresponding to the index (1) of the given modulation and code scheme (I_{MCS}). At the same time, the TU3 may continuously receive new data packets from the user network interface (UNI) and generate the request control message to notify.

The above description may be specific exemplary embodiments for implementing the present disclosure. The present disclosure will include not only the exemplary embodiments described above, but also exemplary embodiments that may be simply redesigned or easily modified. In addition, the present disclosure will also include techniques that may be easily modified and implemented using exemplary embodiments. Therefore, the scope of the present disclosure should not be limited to the exemplary embodiments described above, but should be determined by the claims to be described later as well as those equivalent to the claims of the present disclosure.

What is claimed is:

1. A method of operating a transport unit (TU) for dynamic bandwidth allocation (DBA) in an optical access network, the method comprising:
determining an index of a received signal quality (I_{RSQ}) by measuring a received optical power (ROP) for downstream transmission;
receiving a message of granting authority from a transport node (TN);
transmitting a message of a buffer status report (BSR) to the TN in response to the message of grating authority, wherein the BSR message comprises information on the index of the received signal quality (I_{RSQ});
receiving from the TN a message of bandwidth allocation (BA) comprising an index of a modulation and coding scheme (I_{MCS}); and
determining a modulation and coding scheme (MCS) corresponding to the index of the modulation and coding scheme (I_{MCS}) on the basis of the BA message.

2. The method of claim 1, further comprising:
generating a packet by modulating data to be transmitted into a transport block size (TBS) on the basis of the determined MCS; and
transmitting the packet to the TN through upstream transmission during an allocated upstream transmission time.

3. The method of claim 1, wherein the determining the index of the received signal quality (I_{RSQ}) is performed on the basis of a first mapping table that stores the ROP and the index of the received signal quality (I_{RSQ}) in advance.

4. The method of claim 1, wherein the determining the modulation and coding scheme (MCS) is performed on the basis of a second mapping table that stores the index of the received signal quality (I_{RSQ}) and the index of the modulation and coding scheme (I_{MCS}) in advance.

5. The method of claim 1, wherein the determining the index of the received signal quality (I_{RSQ}) by measuring the received optical power (ROP) for downstream transmission further comprises:
identifying a transmitter power for the TN (P_{TN}) and a transmitter power for the TU (P_{TU}); and
compensating the ROP on the basis of a difference between the P_{TN} and the P_{TU} when the P_{TN} and the P_{TU} are different from each other.

6. The method of claim 1, wherein the determining the index of the received signal quality (I_{RSQ}) by measuring the received optical power (ROP) for downstream transmission further comprises:
determining a received optical power (ROP) that meets a bit error ratio (BER) limit for at least one modulation and code rate.

7. An apparatus of a transport unit (TU) for dynamic bandwidth allocation (DBA) in an optical access network, the apparatus comprising:
a transceiver, and
at least one controller operably connected to the transceiver,
wherein the at least one controller performs:
determining an index of a received signal quality (I_{RSQ}) by measuring a received optical power (ROP) for downstream transmission,
receiving a message of granting authority from a transport node (TN),
transmitting a message of a buffer status report (BSR) to the TN in response to the message of grating authority, wherein the BSR message comprises information on the index of the received signal quality (I_{RSQ}),
receiving from the TN a message of bandwidth allocation (BA) comprising an index of a modulation and coding scheme (I_{MCS}), and
determining a modulation and coding scheme (MCS) corresponding to the index of the modulation and coding scheme (I_{MCS}) on the basis of the BA message.

8. The apparatus of claim 7, wherein the at least one controller further performs:
generating a packet by modulating data to be transmitted into a transport block size (TBS) on the basis of the determined MCS; and
transmitting the packet to the TN through upstream transmission during an allocated upstream transmission time.

9. The apparatus of claim 7, wherein the determining the index of the received signal quality (I_{RSQ}) is performed on the basis of a first mapping table that stores the ROP and the index of the received signal quality (I_{RSQ}) in advance.

10. The apparatus of claim 7, wherein the determining the modulation and coding scheme (MCS) is performed on the basis of a second mapping table that stores the index of the received signal quality (I_{RSQ}) and the index of the modulation and coding scheme (I_{MCS}) in advance.

11. The apparatus of claim 7, wherein the at least one controller further performs compensating the ROP on the basis of a difference between the P_{TN} and the P_{TU} when a transmitter power for the TN (P_{TN}) and a transmitter power for the TU (P_{TU}) are different from each other, in order to determine the index of the received signal quality (I_{RSQ}) by measuring the received optical power (ROP) for downstream transmission.

12. The apparatus of claim 7, wherein the at least one controller further performs determining a received optical power (ROP) that meets a bit error ratio (BER) limit for at least one modulation and code rate, in order to determine the index of the received signal quality (I_{RSQ}) by measuring the received optical power (ROP) for downstream transmission.

13. An apparatus of a transport node (TN) for dynamic bandwidth allocation (DBA) in an optical access network, the apparatus comprising:
a transceiver, and
at least one controller operably connected to the transceiver,
wherein the at least one controller performs:
transmitting a message of granting authority to a transport unit (TU),
receiving a message of a buffer status report (BSR) from the TU in response to the message of grating authority, wherein the BSR message comprises information on an index of a received signal quality (I_{RSQ}),
determining an index of a modulation and coding scheme (I_{MCS}) in response to the index of the received signal quality (I_{RSQ}),
transmitting to the TN a message of bandwidth allocation (BA) comprising the index of the modulation and coding scheme (I_{MCS}), and
determining a modulation and coding scheme (MCS) corresponding to the index of the modulation and coding scheme index (I_{MCS}) on the basis of the BA message.

14. The apparatus of claim 13, wherein the at least one controller further performs determining a transport block size (TBS) of data to be transmitted on the basis of the MCS corresponding to the index of the modulation and coding scheme (I_{MCS}) before the performing transmitting the BA message, wherein the BA message further comprises a transmission time and transmission window size of upstream transmission and the TBS.

15. The apparatus of claim 13, wherein the transmitting the BA message is performed in consideration of a round trip delay, (RTT) and an upstream transmission preparation time.
